(19) United States
(12) Patent Application Publication
(10) Pub. No.: US 2009/0157487 A1
(43) Pub. Date: Jun. 18, 2009

(54) System and Method for Collection, Validation and Communication of Competitive Pricing Data

(76) Inventors: Christine B. Cottrell, Richmond, VA (US); Kim K. Irvine, Richmond, VA (US); David R. Garcia, Midlethlan, VA (US)

Correspondence Address: WILLIAMS MULLEN, 222 CENTRAL PARK AVENUE, SUITE 1700, VIRGINIA BEACH, VA, 23462, US

(21) Appl. No.: 12/338,525

(22) Filed: Dec. 18, 2008

Related U.S. Application Data
(60) Provisional application No. 61/008,042, filed on Dec. 18, 2007.

(51) Int. Cl. G06Q 99/00

(52) U.S. Cl. 705/10

(57) ABSTRACT

A system, apparatus and method employ or embody voice-enabled mobile devices to facilitate quick, cost-efficient and accurate collection of pricing data for consumer products offered by multiple retail establishments. A consumer goods price tracking component aggregates the collected pricing data into good-price pairs, good-price-sale triplets and/or good-price-value triplets, whereupon it can be communicated to a price management and analytics component for assessment and eventual reporting. The present invention can be adapted for use with systems that facilitate subscriber pricing decisions through enhanced tools for pricing analytics, price savvy price management, price warehousing, data management and manipulation, and competitive audits.

### CROSS-REFERENCE TO RELATED APPLICATIONS

The present application claims the benefits of U.S. Provisional Application Ser. No. 61/008,042, filed Dec. 18, 2007, entitled “System and Method for Collection, Aggregation and Dissemination of Competitive Pricing Data,” which is incorporated herein by reference.

### TECHNICAL FIELD

The present invention pertains generally to mobile devices used in data collection, processing and management, and more particularly to a system, apparatus and method employing or embodying voice-enabled mobile devices to facilitate price management, pricing analytics, competitive audits and other beneficial commercial products and services.

### BACKGROUND

Competitive price audits assist retailers and manufacturers in providing the most competitive, timely and profitable pricing plans for their wares. Big box retailers, grocery stores, other retailers and product manufacturers are highly competitive on price, and the slightest price adjustment can affect product sales immensely.

In performing price audits in the past, third party data collectors have typically entered into a retail store with a pen and clipboard or other manual way of recording pricing information. Upon obtaining the required price information (whether everyday price, sale price, rebate adjusted price, membership card price, for example), the field agent would return to an office to aggregate the pricing data so that it could be reported to subscribers, such as other retailers and/or manufacturers, for example. In some instances, barcode scanning software has been employed by field agents to scan a product's unique code, which reduces data collection time and can improve accuracy.

Past price data collection efforts have failed in circumstances where retailers prohibit price collection (at least overt collection efforts), products are improperly tagged, the data recorded by the field agent is inaccurate and/or where the collected data is inaccurately transferred to a report or database.

In addition to price collection failures, past communications systems and analytical systems have failed in providing subscribers with real-time or near-real time, accurate and meaningful information to make better pricing decisions.

### SUMMARY OF THE INVENTION

The present invention enhances price collection efforts by providing a voice recognition system adapted to complement bar code scanning and other forms of data collection in order to reduce data collection costs and increase accuracy. The present invention can further work with systems that facilitate subscriber pricing decisions through enhanced tools for pricing analytics, price savvy price management, price warehousing, data management and manipulation, and competitive audits.

### BRIEF DESCRIPTION OF DRAWINGS

FIG. 1 shows an illustrative schematic architecture of one embodiment of the system of the present invention.

FIGS. 2 through 4 show sample flow diagrams illustrating methods of collecting data in accordance with embodiments of the present invention.

FIG. 5 is a schematic diagram illustrating components of the mobile device and the processing engine of the present invention.

FIG. 6 is an illustrative schematic diagram of a program layout associated with the present invention.

FIG. 7 is a sample price input user interface displayed on the data collection device in accordance with one embodiment of the present invention.

FIG. 8 shows an illustrative schematic architecture of an alternative embodiment of the system of the present invention.

### DETAILED DISCLOSURE OF INVENTION EMBODIMENTS

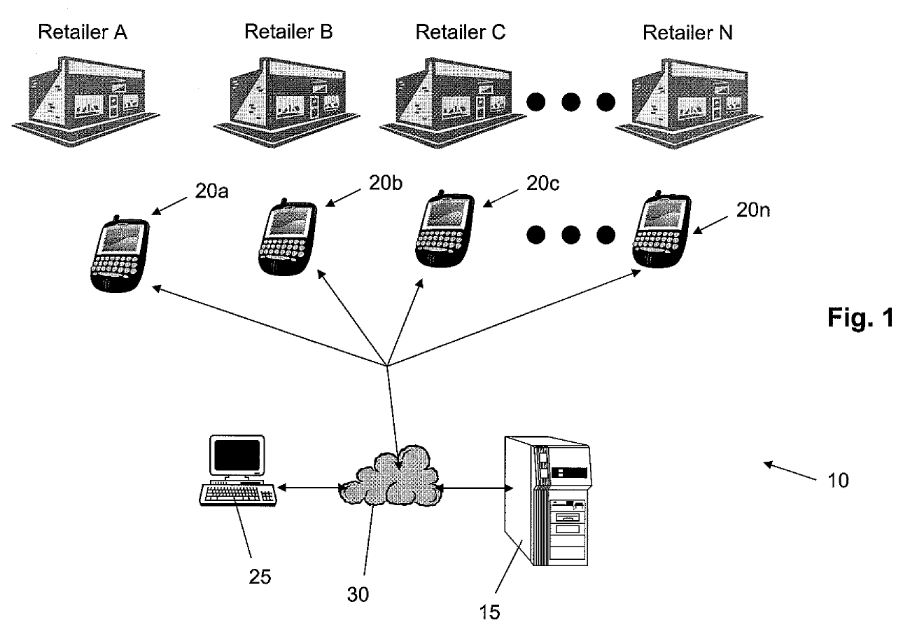

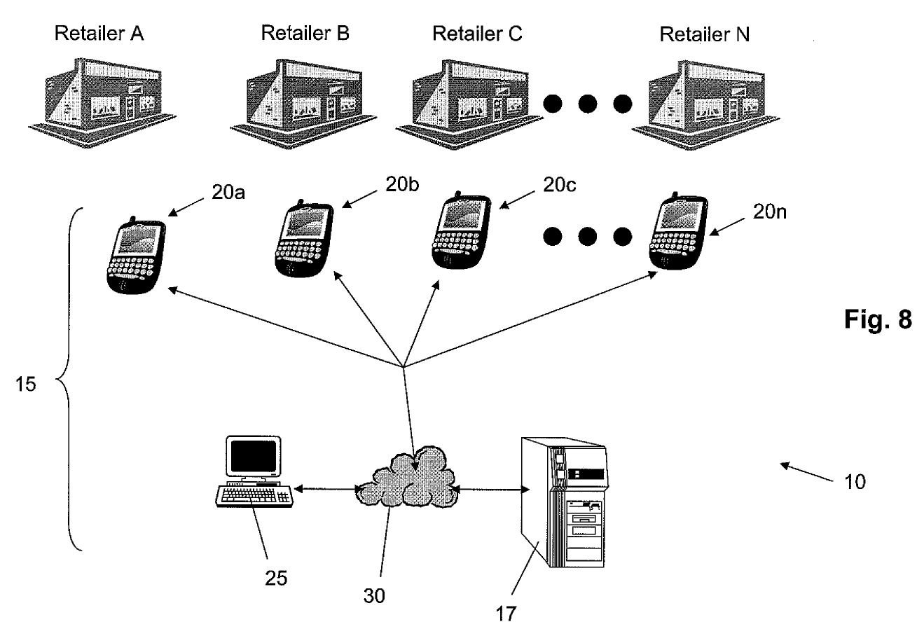

As shown in FIG. 1, the present invention comprises a competitive pricing system 10 for use in connection with retail establishments (such as Retailers A-N, for example), including a processing engine (“engine”) 15, data collection apparatuses 20a-n, an administrative user component 25 and a network 30 facilitating electronic communications there between. In one embodiment of the present invention, network 30 is the Internet. In another embodiment of the present invention, the network 30 is a private network and can include an Intranet-type network for communications between user component 25 and engine 15. In one embodiment, as shown in FIG. 1, for example, the engine 15 is a back-office computer system connected to a network 30 that is capable of receiving and communicating directed list information to the data collection device(s) and receiving uploaded information from the device(s). In another embodiment of the present invention, as shown in FIG. 8, for example, the engine 15 comprises the collective processing capabilities of multiple components including the data collection devices 20a-20n and a back-office computer system 17.

In one embodiment of the present invention, each user of a data collection apparatus (e.g., 20a) enters into a respective retail establishment (e.g., any of Retailers A-N) for the purposes of collecting price data for consumer products. Each user can be provided with an assignment to collect price data for specific products, or users can be provided with no specific instructions, whereupon the users operate to collect whatever price data they can. The price data is collected and recorded via the data collection apparatus, and can further be transmitted to the engine either during or after price collection activities. By collecting price data from several locations using multiple devices operated by different users at or near the same time, the present invention facilitates an accurate and timely comparison of pricing information to assist product manufacturers, retailers, marketers and others in appropriately pricing their wares to adjust their competitive position (e.g., providing a lower price to be more competitive and effectively benefit consumers) and/or to maximize their profit potential. Further, the present invention facilitates the quality and accuracy of the data at the point of collection using validation processes discussed hereinafter.

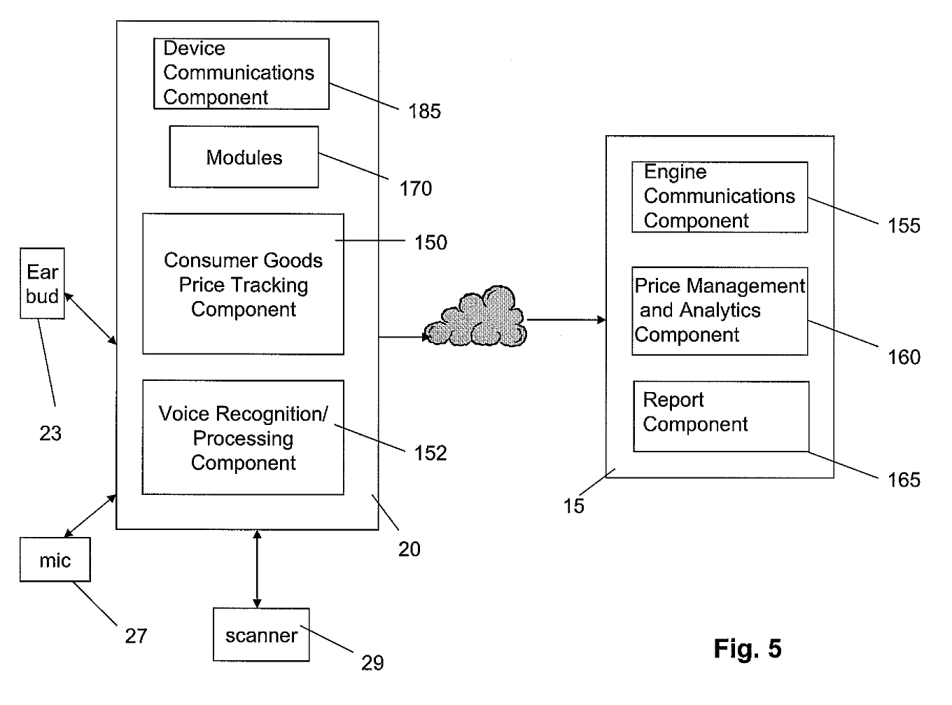

For collecting price data, each data collection apparatus 20 is provided with a consumer goods price tracking component 150, as shown in FIG. 5. The component 150 can comprise suitable software programming for associating consumer good identification information with a retail price received from each user of the data collection apparatuses so as to provide a respective good-price pair for each of a plurality of goods for each retail establishment. The consumer good identification information can be a product name (e.g., Kleenex™ brand tissues), product type (e.g., tissues), product bar code, product bar code representation (e.g., digital representation), product size, product expiration date information or other information that identifies the product or an aspect of the product. The good-price pair is thus two items of information that are tied together—e.g., the actual consumer good (e.g., 6-pack of twelve ounce cans of Sprite™) and its price in the given retail establishment (e.g., $2.99). It will be appreciated that the good-price pair can include additional information associated with either the product or the price, such as, for example, a notation that the product is on sale, available at a discount to loyalty group members, available at a discount because of a near-term perishability date, or other factor encountered in retail pricing. When a sale identifier is added to the good-price pair, the good-price pair becomes a good-price-sale triplet. When a value identifier is added to the good-price pair, such as when the price for the particular product represents a discount or other benefit based on a shopper's membership in a loyalty, rewards or similar program, for example, then the good-price pair becomes a good-price-value triplet.

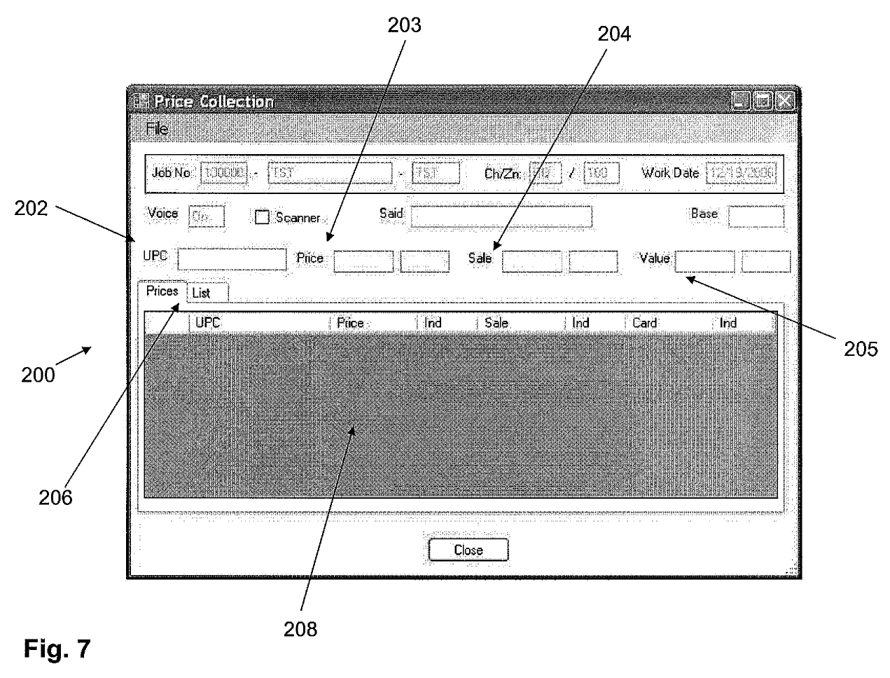

FIG. 7 shows a sample user input screen 200 in accordance with one embodiment of the present invention. As shown in FIG. 7, fields such as a product identifier (e.g., UPC) field 202, price field 203, sale field 204, value field 205 and other fields are shown, for which values or information can be input by the user and displayed to the user. In one embodiment of the present invention, the product identifier information can be provided for each product in a directed list that has been downloaded by the device from the processing engine, and which may have been initially provided by an administrative user of interface 25. In another embodiment of the present invention, the product identifier information is called up by the device's price tracking component 150 once the user scans the product code or otherwise inputs the product identifier (e.g., through voice, key-in, or image collection and recognition). As further shown in FIG. 7, tabs 206 can be provided to allow the user to toggle between different displays within the price input screen. For example, when the user accesses the “prices” tab, the aggregate display area 208 can show price and other information for several products at one time in list fashion. When the user accesses the “list” tab, the directed list of products for which prices must be collected is displayed.

It will be appreciated that the consumer good identification information can be pre-established in the collection apparatus memory, such as in the instance where an assignment of products is communicated to the collection apparatus, or the consumer good identification information can be entered into the data collection apparatus memory by the user through scanning, voice, or other data entry technique in accordance with the present invention.

The data collection apparatus or device 20 is a mobile device that can take various forms (e.g., handheld computer, mobile phone, laptop, personal digital assistant (PDA), scanner with wireless transmitter, etc.) and can communicate data to the engine. Small form factor devices are preferred due to their size and versatility. In one embodiment, the data collection apparatus of the present invention can operate on Microsoft Windows CE™ operating system. In another embodiment of the present invention, the data collection apparatus is a handheld scanner that can collect pricing information through the bar code on the product being scanned. One example of this type of device is the Symbol® MC70, commercially available from Symbol Technologies, Inc., a subsidiary of Motorola, Inc.

In one embodiment, each data collection apparatus (e.g., mobile device) is operated by a different individual user in a unique physical retail establishment such that no two devices are operated in the same physical retail establishment at the same time. It is also foreseeable that multiple users can operate multiple devices within the same retail establishment at the same time for various reasons, such as to speed up the data collection process.

In one embodiment of the present invention as mentioned above, data collection apparatus 20 is voice-enabled and comprises a portable device having a microphone input electronically connected to a voice activated software program (i.e., voice recognition/processing component 152 in FIG. 5) that can accept price and other relevant information in audio format. This allows the individual collecting price information to speak the information into the microphone (27 in FIG. 5) rather than scan or write down the information. In this way, post audit transcribing is avoided, and validation of a unique product code symbol (e.g., UPC, PLU, and/or proprietary item coding) can be performed at the shelf in the retail establishment. It will be appreciated that devices having combined auditory and scanning capabilities can also be employed as the data collection apparatus 20. As shown in FIG. 5, for example, the device 20 is represented with an earbud 23 and a scanner 29 for these purposes. In a further embodiment of the present invention, the device is provided with a camera for capturing an image of the displayed price, the displayed product code and/or a combination of the displayed price and product code. In this embodiment, the device is further provided with optical character recognition software for scanning/reading the image and recognizing the relevant characters therein to capture the price and product information (e.g., the good-price pair).

Once scanned, spoken or otherwise entered into the data collection apparatus, the information can be stored locally in a computer memory associated therewith (not shown in FIG. 5) and later communicated to the engine 15, such as through the communications components 185, 155 described hereafter. In one embodiment of the present invention, the transmission of data from the device can occur as batch files transmitted over a wireless Internet connection, for example.

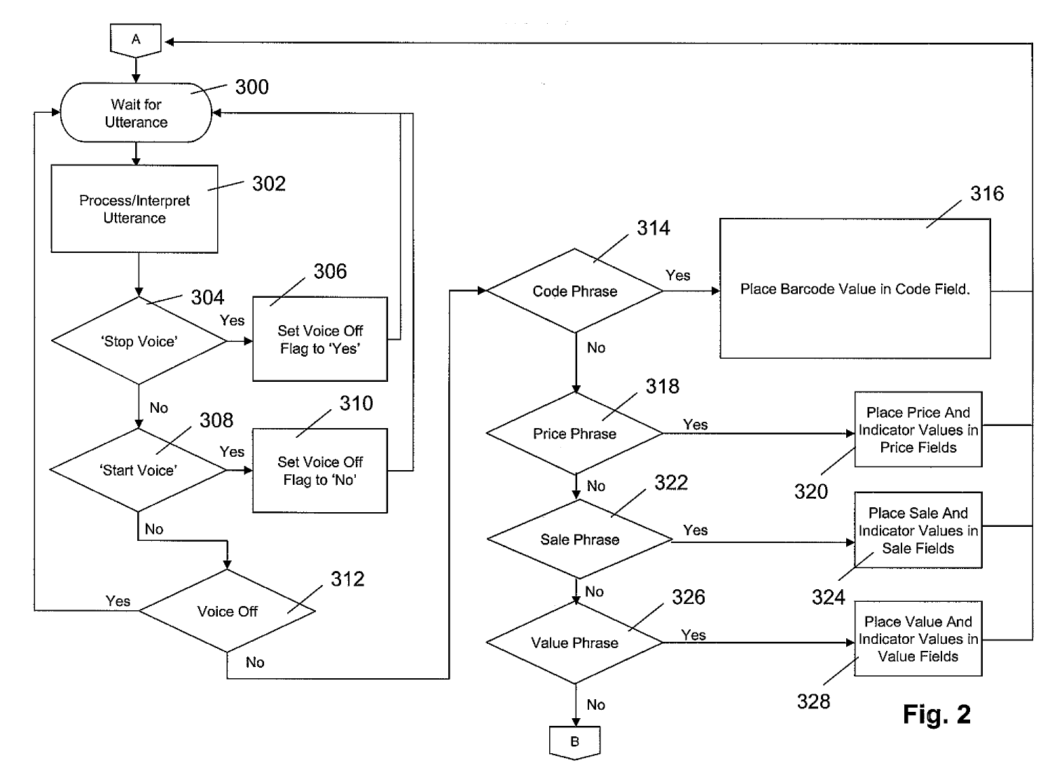

Further details regarding the voice activated software are shown the flow chart in FIGS. 2 through 4 illustrating one embodiment of steps followed according to the command-driven logic of the present invention. As shown in FIG. 2 and beginning at “A,” the system waits for an utterance (step 300) by the user of the mobile data collection apparatus. In one embodiment, the apparatus comprises a microphone, a transmitter, a receiver, an earbud (ear piece), a processor and a memory. The processor can execute programming stored in the memory, including voice recognition software provided as part of the voice recognition/processing component 152 of the present invention, and including consumer goods/price tracking component 150, as shown in FIG. 5. In one embodiment of the present invention, voice recognition software is provided by Nuance Communications, Inc. of Burlington, Mass. or other suitable speech recognition software provider. In another embodiment of the present invention, the Microsoft Vista™ voice engine is employed in addition to or instead of the Nuance voice engine.

When the utterance is picked up by the microphone, the voice message is transmitted by the transmitter to the receiver. The utterance is then processed/interpreted (step 302) by the voice recognition/processing component. If the “Stop Voice” command is encountered (step 304), the Voice Off flag is set to Yes (step 306) and the software returns to wait for the next utterance (step 300). If the “Start Voice” command is encountered (step 308), the Voice Off flag is set to No (step 310) and the software returns to wait for the next utterance. In the event any other command is received, if the “Voice Off” flag is positive as determined at step 312 (meaning the voice recognition is off), then the system will ignore the command and wait for the next utterance. If the “Voice Off” flag is negative (meaning the voice recognition is on), then the system will continue processing the command.

As further shown in FIG. 2, in one embodiment of the present invention, the utterance can be a code phrase, a price phrase, a sale phrase or a value phrase. The value phrase can correspond to a price associated with a user having a membership/rewards card associated with the retailer being audited. If the utterance is a code phrase as determined at step 314 (such as the user dictating the code numbers from the bottom of a unique product code, for example), then, as indicated at step 316, the system places the received barcode value in the code field 202 on the user interface display 200 of the device, as shown in FIG. 7, for example. In alternative embodiments of the present invention, the code phrase can be a short phrase stated as a predicate to actual code entry, or can be the actual code entered by scanning, voice or other entry means. If data was previously entered for another unique product code symbol, then the device 20 can save that data. If a job was not downloaded, then the device returns the price history for the product bearing that unique product code symbol (e.g., UPC, PLU, and/or proprietary item coding and loads it into the price field, which enables the user to quickly compare the historical price with the current price and ultimately simplify the data entry if the historical price is the same as the current price. In such an instance, the user may simply enter a confirmation command into the device. In one embodiment of the present invention, the price history is not made available if the job (e.g., directed list) was downloaded, because this might enable an unscrupulous data collector to avoid performing their job by merely accepting the historical price for each product as the actual current price. If the ‘Lock Price’ function is active, then the system can use previously entered price information. It will be appreciated that the same process can be followed whether the code information is spoken or scanned from a barcode scanner. In this way, the present invention provides redundant capabilities for collecting information obtained via code. In one embodiment of the present invention, the user identifies a consumer good to the mobile device by speaking the product brand and name, as opposed to a code.

If the utterance is a price phrase (step 318), then price and indicator values are placed in the price fields (step 320). In one embodiment of the present invention, the user identifies a retail price for a consumer product by speaking the price in U.S. dollars and cents. It will be appreciated that the present invention contemplates identifying prices in non-U.S. currency as well. The indicator value can be a series of words indicating whether the price is a short term price or long term, or if the product is out of stock, for example. In one embodiment of the present invention, expiration dates for perishable products are recorded alongside price information to indicate and/or explain distinctions between prices for a particular product sold at multiple locations based on the time remaining until expiration.

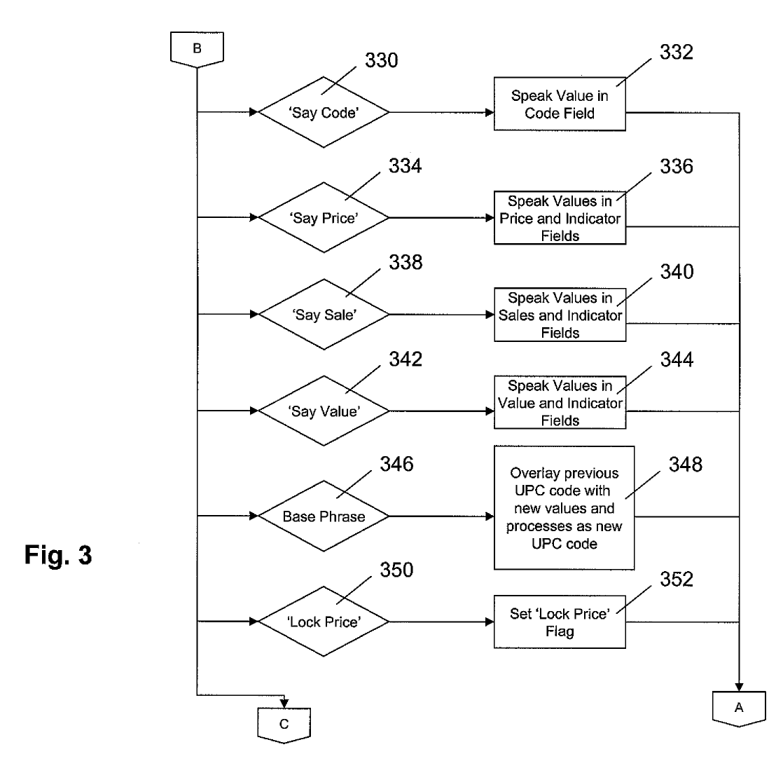

If the utterance is a sale phrase (step 322), then sale and indicator values are placed in the sale fields (step 324). If the utterance is a value phrase (step 326), then value and indicator values are placed in the value fields (step 328). In this way, the database of price, sale and value fields can be filled for a variety of products. All of the entries can then be represented visually such as on a display 200 as shown in FIG. 7, for example. In addition, as indicated by the top decision point, if the utterance is one that turns the software off, then the system sets the Voice Off flag to “yes” and returns to point A to await another utterance. Otherwise, the process flow can continue via point “B” to FIG. 3.

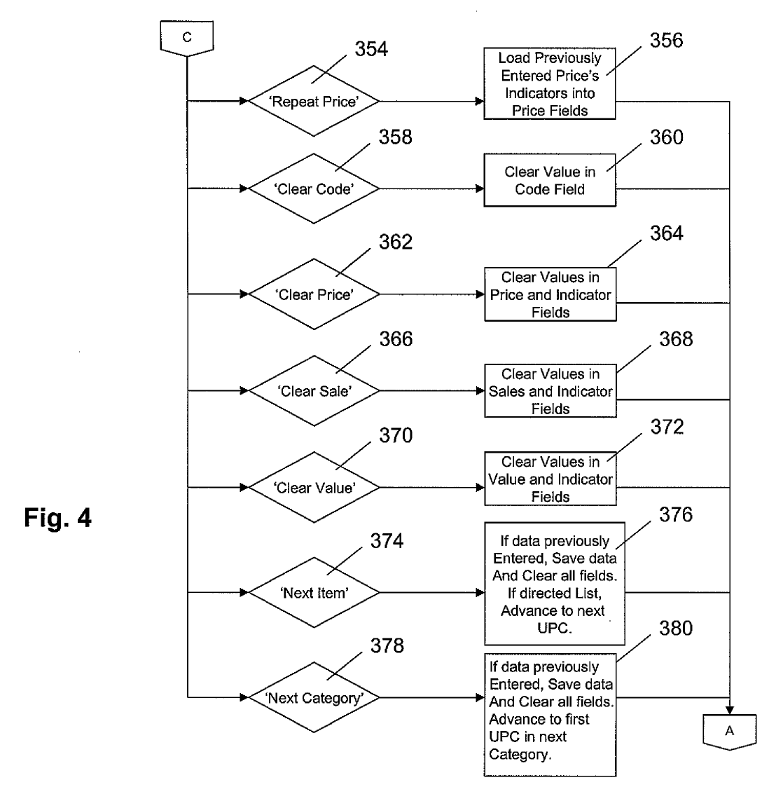

As further shown in FIG. 3 and starting at “B,” in one embodiment of the present invention, the user can have the device speak back the value in the UPC code field by stating the phrase “Say Code” out loud into the microphone (step 330). In this embodiment, the device computer/processor can then initiate a process through an associated module (e.g., CPA Detail module described below) to return an audible response (step 332) through the speaker maintained by the user (e.g., earbud). Further, after speaking this phrase, the user can then change the value for the code if necessary, and the new code will be stored in the code field and displayed on the user interface display of the device 20. In this instance, the user states a base phrase (step 346), and then the system overlays the previous unique product code with new values and processes this as the new unique product code (step 348, which is similar to “code phrase” (step 314) in FIG. 2). The user can similarly initiate the repeating of the price, sale and value input by saying “Say Price” (step 334, which initiates the audible price information response as at step 336), “Say Sale” (step 338, which initiates the audible sale information response as at step 340), or “Say Value” (step 342, which initiates the audible value response as at step 344) respectively. By saying “Lock Price” (step 350) the user can set the “Lock Price” flag for the present invention (step 352). When the “Lock Price” flag is set, the pricing information entered for the previous UPC is carried forward and automatically placed in the pricing fields when a new UPC code is entered. It will be appreciated that the user can receive an audible response back from the device through the speaker, ear bud or ear piece once the user dictates information through the microphone to the device. In this way, the user can determine whether the input received by the device matches what the user had spoken, which improves the accuracy of, and serves to validate, the data being obtained. Other items the user can speak extend to point “C” which carries over into FIG. 4.

As indicated in FIG. 4 and beginning at “C,” if the user says “Repeat Price” (step 354) the device loads the previously entered price's indicators into the price fields (step 356). If the user says “Clear Code” (step 358), the device clears the value in the code field (step 360). If the user says “Clear Price” (step 362) the device clears the values in the price and indicator fields (step 364). If the user says “Clear Sale” (step 366) the system clears the values in the sale and indicator fields (step 368). If the user says “Clear Value” (step 370) the system clears the values in the value and indicator fields (step 372). If the user says “Next item” (step 374) the system checks to see if data was previously entered, saves the data and clears all fields (step 376). If the user had been provided with a directed list, which means that the user was specifically directed to obtain price information for a specific list of items, then the device can advance to the next UPC on the list (also step 376). The directed list and/or assignment instructions can be conveyed by the processing engine to the mobile data collection devices via communications component. For example, the consumer good identification information can be downloaded from the processing engine. In another embodiment, the assigned consumer good identification information is pre-stored in the consumer goods price tracking component of the mobile device prior to the user entering the retail establishment. In the embodiment of the present invention where the user is not given a list or assignment, the consumer good identification information can be entered by the user through a barcode scan, oral communication, or manual key entry, for example.

If the user says, “Next category” (step 378) then the system checks to see if data was previously entered, saves the data and clears all fields (step 380). The system then proceeds to the first UPC in next category of the directed list (also step 380), in the embodiment of the invention where a directed list is involved. It will be appreciated that the user may not receive a directed list, but instead is given an undirected job. In such cases, the user may proceed to obtain pricing information for all available products or for a pre-determined type, grouping or other portion of products within a given targeted store.

As shown by the indicator to A in FIG. 4, the process repeats itself to handle all further incoming spoken messages. In one embodiment of the present invention, the voice software can be fine tuned or calibrated according to methods associated with the present invention to reduce background noise. Reducing background noise allows the present invention to speed up voice processing as well as user confirmations that the data collection apparatus received accurate spoken information. In one embodiment of the present invention, background noise can be reduced such that an auditor can input hundreds of items per hour into the data collection device.

Background noise reduction can be accomplished by adjusting various parameters within the voice engine. As each utterance is processed, the voice engine returns a confidence level for the phrase returned by the engine. By adjusting the tolerance level of the confidence information provide by the voice engine, invalid phrase recognitions that are generated by background noise can be reduced, mitigated and/or eliminated. Additionally, each word within the command phrase is returned with its own confidence level. The confidence levels are also checked to ensure that they meet the tolerance levels set by the application. If any given word confidence level fails to meet the acceptable level, then the whole command phrase is discarded.

Background noise can further be mitigated through the use of an accuracy setting on the voice recognition/processing component, allowing for a trade off of processing (i.e., CPU) load and memory usage versus processing time. The higher the accuracy setting, the less background noise will impact the recognition process. There is a trade-off, however, on this setting, as the higher the accuracy setting, the slower the recognition process performs. Background noise can further be mitigated through proper training of a given user or users on the voice recognition element.

It will be appreciated that the system of the present invention can operate such that no mobile device receives any communication from the processing engine while in a retail environment. Such a situation may arise, for example, when a particular retail store is not in range of a wireless network, and the data collection device can then store collected information locally for local processing or for later transmission to the processing engine 15 in the embodiment where the processing engine is separate and apart from the collection device(s).

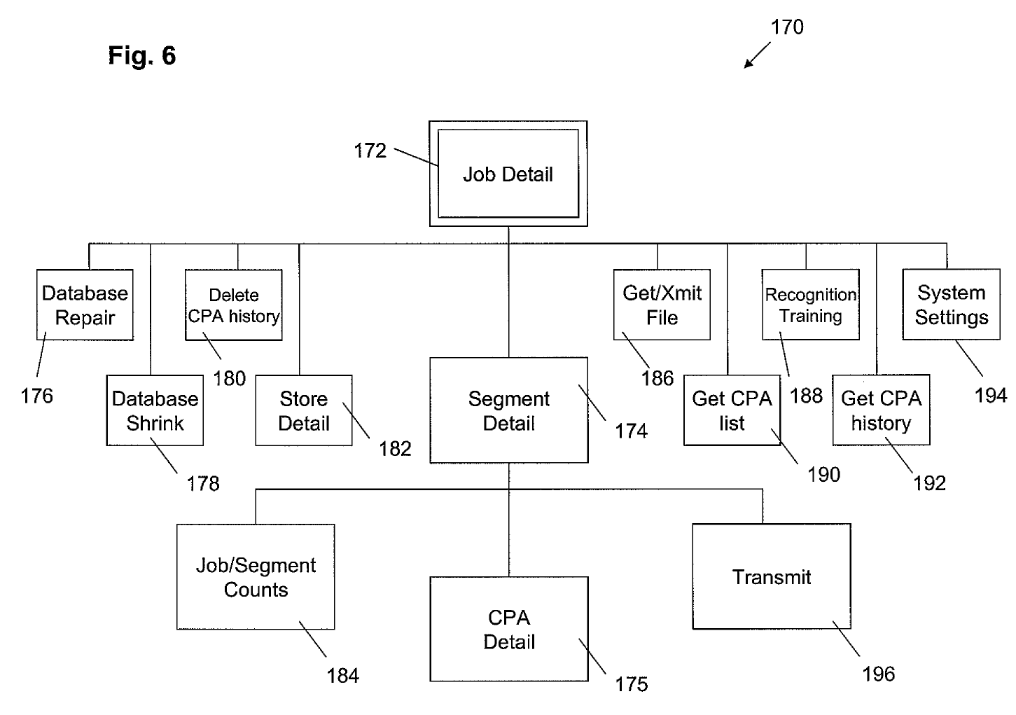

As shown in FIGS. 5 and 6, each device 20 can be provided with multiple programmed modules 170 for performing functions relevant to the operation of the present invention. In one embodiment of the present invention, the device includes one or more programmed modules for facilitating information collection as well as validation of the collected data. In one embodiment of the present invention, a programmed module provides the command flow logic such as that shown in FIGS. 2 through 4, for example, and described above in facilitating the information collection from the one or more devices. This module is thus responsive to the voice commands received from the data collector to audibly confirm and validate the retail price received by voice from the data collector as describe above, for example.

For example, it is possible that price, sale, value or other data collected by the user is erroneously recorded by the device. In such an instance, a module can detect an error automatically (such as where, for example, the price value for a given product is well out of range from historical price values), or the error can be detected through the verbal confirmation processes described above. When errors are detected, the device module can provide a visual or auditory response to the user. For example, when the incorrect unique product code is scanned, the device can emit a “beep” sound that the user can hear. As a finer example, when a price is entered that is well out of range for the given product, the display of the mobile device can be provided with an error representation graphic for revealing that an error in input has been discovered. As a further example, when a price is entered, regardless of whether it is considered out of range of historical data, the device can audibly request the user to confirm that it is correct, such as by emitting an audible message such as “Are you sure?” or presenting a message on the device display. Price validation can also occur through the audible repetition of the price by the device such that the user can hear the amount that has initially been received by the device, and then compare it to what the user recalls having spoken and/or with the price as reflected in connection with the product in the retail environment. In one embodiment of the present invention, the CPA Detail module 175 (shown in FIG. 6) is the module employed for price and other information collection and validation processes.

As shown in FIG. 6, the modules can include a Job Detail module 172, a Segment Detail module 174, and a CPA (Competitive Price Audit) Detail module 175, as well as modules for Database Repair 176, Database Shrink 178, Delete CPA History 180, Store Detail 182, Job/Segment Counts 184, Get/Xmit File 186, Recognition Training 188, Get CPA List 190, Get CPA History 192, System Settings 194, and Transmit 196.

The Job Detail module 172 provides the ability to add, update and delete the Job Detail data. This data represents the highest level in the data structure and serves as the parent record representing a single job to be completed. The Segment Detail module 174 provides the ability to add, update and delete the Segment data. This data represents the middle tier information regard a specific data collection episode within a single job occurrence.

In addition to performing functions described elsewhere herein, the CPA Detail module 175 provides the ability to add, update and delete the individual pricing data for a specific UPC code. This data represents the lowest tier information regarding a specific UPC code collected during a single data collection episode (segment). The CPA Detail module provides the voice recognition data capture capability.

The Database Repair module 176 provides the ability to perform an analysis on the database to determine if any internal issues have arisen as a result of data collection. This module will identify and correct the problems if possible. The Database Shrink module 178 provides the ability to recapture unused database space that has been created as a result of the deletion of data. The process will decrease the amount of disk space occupied by the database. The Delete CPA History module 180 provides the ability to delete pricing history stored within the database for a specific store.

The Store Detail module 182 provides detailed store information for jobs that have been downloaded to the application. The Get/Xmit File module 186 provides the ability to either retrieve (Get) or send (Xmit) any file specified. In the embodiment of the present invention where file transfer protocol (FTP) is employed, the specified file is moved between the root directory on the FTP server and the Program Files directory of the handheld device.

The Get CPA List module 190 provides the ability to retrieve a file that defines the specifications to be used to collect pricing data for a specific list of UPCs. The process will automatically create the associated Job Detail record as well as the first Segment Detail record.

The Get CPA History module 192 provides the ability to retrieve a file that contains previously collected pricing history for a specific store. This pricing history is used to provide pricing variance testing during the price collection process.

The Recognition Training module 188 provides the ability for the user to train the voice engine to their specific voice. The user is provided a script of words to be read during the training process. The System Settings module 194 provides the ability to store and maintain system and voice engine parameters. The Transmit module 196 provides the ability to package the pricing data collected within an individual segment and transmit that package to the processing engine for further processing. During the submission of the transmit request, the end user can be required to provide payroll information through the entering of store time, drive time and mileage.

With reference again to FIGS. 1 and 5, the engine 15 can comprise a computer processor or series of servers performing processing functions in accordance with the present invention. In one embodiment of the present invention, the engine 15 serves as a communication portal compiling and providing collection information and criteria to the apparatus for collection and for receiving and storing collected information from the apparatus. As shown in FIG. 5, the engine 15 includes an engine communications component 155 for enabling wireless and wireline communication of, among other information, directed list information from the processing engine to the device(s) and/or the associated good-price pair for each of the plurality of goods from the data collection devices to the processing engine. The engine communications component can comprise one or a series of PC servers for handling communications functions, facilitating communications using Internet protocol (IP) over one or more secure local area networks (LANs) or wide area networks as is known in the art. Each device 20 also includes its own device communication component 185 for facilitating the same communications, and the device communications component can comprise appropriate hardware and software for enabling message transmissions in accordance with the present invention.

As described above, the engine 15 is provided as part of the data collection, storing and analytical aspects of the present invention. As pricing information is collected, including the everyday retail price, sale retail price, value price and/or rebate-adjusted price, it can be recorded for a given product or line of products. The stored information can be transmitted from the data collection apparatus from the field to the engine as described above. The present invention contemplates using the engine to reflect any brand linking among multiple products, whether an item is new or discontinued, its level of distribution, in stock/out of stock status, whether it has been on sale or discounted for a short term or long term, whether the price as collected can be verified and where it is offered for sale. Such items can be categorized as part of the indicator field described above.

In one embodiment of the present invention, as shown in FIG. 5, the engine 15 further includes a price management and analytics component 160 as well as a reporting component 165. Component 160 can be employed for comparing multiple retail prices obtained by the mobile devices for a single good and performing other data manipulation, analysis and management activities. In one embodiment of the present invention, for any good having more than one good-price pair, the price management and analytics component first computes an average price for the good before the good-price pair is represented via the report component. Component 165 can be employed for representing the received good-price pairs, good-price-sale triplets, and/or good-price-value triplets in an output display. The output display can be a screen image or a physical hard copy report, for example.

In one embodiment of the present invention, the administrative user component and/or user interface 25 is provided for receiving, managing and communicating directed lists and/or assignments to individual users of the data collection apparatuses.

FIG. 6 shows an example program layout diagram 12 illustrating one embodiment of how different functions and interfaces can be employed using the processing engine 15.

In setting up the engine 15 for a particular client, a user interface 25 can be provided that allows a user to input a particular client's market, competitors, items desired to be covered, directed list and frequency of report, for example. Detailed definitions of the type of report the client would like to see can also be entered.

### Example Implementation

A certain client requires pricing information on tortilla chips, from name brand through generic or private-label brand. Twelve agents are dispatched to twelve different retail locations, with each agent carrying a data collection apparatus into a respective retail location. Each data collection apparatus 20 has received brand, size and other product offering information from the processing engine 15 on all of the name brand tortilla chips pursuant to a directed list portion of the assignment, but has no name, size, code or other identifying information for the generic tortilla chips. The assignment thus includes a directed list portion, as well as an undirected portion, whereby the agents are asked to obtain whatever additional price data they can for tortilla chip offerings that are not part of the directed list. In one embodiment of the present invention, an assignment that includes both a directed list component and an undirected portion requires separate job numbers for data management purposes.

A first agent employs a barcode scanner in connection with his or her data collection apparatus in order to scan in each barcode from the generic tortilla chip packages. As an example, with three different generic tortilla packages in a given retail store, the first agent collects a first barcode using the scanner (e.g., for a six ounce bag of tortilla chips), a second barcode using the scanner (e.g., for a thirty-two ounce bag of tortilla chips) and a third barcode using the scanner (e.g., for a ninety-six ounce bag of tortilla chips). After the first agent scans the first barcode, the consumer goods price tracking component identifies the product, displays a status on the data collection device display that indicates that the data collection device is ready to receive the price for the product, and then the agent communicates the price for the first barcode product into the data collection device. It will be appreciated that, while a scanner associated with the given retailer may already know what the price for the product associated with the scanned barcode is, the agent's device will not know this price simply by scanning the barcode, as the agent's device is not part of the retailer's private computer system. Thus, the agent must use one of several means to enter the price or other information for the product whose barcode has been scanned. In the embodiments of the present invention, the method of conveying the price can be by voice, image scan or keyboard entry, for example. It will be appreciated that the agent may encounter the same product at different times or places during a given assignment, and may therefore enter a price for the same product twice. In one embodiment of the present invention, this event is handled by overwriting the initially recorded price with the second price obtained for the product.

Separately, for each product where the first agent has identifying information, the user can scan the barcode and enter price information. In the example for this first agent, none of the products are on sale (i.e., incorporate a sale identifier) or qualify for a promotion, benefit, discount or other change in price based on membership in a rewards or loyalty system (i.e., incorporate a value identifier). Thus, the good-price pairs for all products are presented by the consumer goods price tracking component of the data collection device to the price management and analytics component of the processing engine 15.

A second agent employs the voice input aspects of the present invention, so instead of scanning the generic and name brand barcodes, the user speaks the numeric representation for the barcodes of each commercial offering into the microphone on the data collection apparatus. After each spoken code, the consumer goods price tracking component identifies the product, displays a status on the data collection device display that indicates that the data collection device is ready to receive the price for the product, and then the agent speaks the price for the given product into the data collection device. For the second agent, some of the products are identified as on sale, so the agent makes the appropriate communication through the microphone for those products on sale, and the consumer goods price tracking component records the good-price-sale triplet for such sale products. The remaining non-sale products have no value identifier, either, so these remaining non-sale products are represented to and by the consumer goods price tracking component as good-price pairs.

For the third agent, some of the products are on sale, some are tagged with a value identifier, and some are neither on sale or have a value identifier The third agent proceeds to collect the price information for each assigned product and any non-assigned tortilla chip products in one of the manners as disclosed above. For all products, one of a good-price pair, good-price-sale triplet or good-price-value triplet is input into the consumer goods price tracking component, which communicates the information to the price management and analytics component of the processing engine 15.

The variables and existence of sale or value identifiers for the fourth through twelfth agents can vary or be the same as one of the above examples. Once each agent has collected and entered the required data into the data collection apparatus, it can be communicated via communications component to the processing engine. The price management and analytics component can manage the incoming data and implement report component 165 so as to provide the client with a summary of information in a manner that is meaningful to the client. The price management and analytics component can further compare multiple retail prices obtained by the mobile data collection devices for a single product or good.

As a result, the client may learn, for example, that a specific name brand of tortilla chips has been offering its chips at a seven percent discount over its historical average for the same product. If the client is a competitor, the client may then elect to reduce its prices accordingly so as to avoid a negative impact on sales. If the client is a retailer, the client may decide to order more of the discounted product in anticipation of being sold out of the product more quickly than usual.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A system, comprising:
a voice-enabled mobile data collection device having a display and being adapted to receive voice commands from a user as the user moves through a physical retail environment;
a processing engine providing consumer good identification information to the devices; and
a consumer goods price tracking component associating the consumer good identification information with a retail price received by voice from the user of the mobile data collection device so as to provide an associated good-price pair for each of a plurality of goods;
a programmed module responsive to the received voice commands to audibly confirm, and validate, at least the retail price received by voice from the user.

2. The system of claim 1 wherein the data collection device receives voice commands including a code input command, a price input command and a repeat price command.

3. The system of claim 1 wherein the consumer good identification information is entered by the user through one of: barcode scan, oral communication, key entry, captured image for optical character recognition.

4. The system of claim 1 including a plurality of voice-enabled mobile data collection devices, wherein each mobile device is operated by a different individual user in a unique physical retail establishment such that no two devices are operated in the same physical retail establishment at the same time.

5. The system of claim 1 wherein a user identifies a consumer good to the mobile device by speaking the product brand and name.

6. The system of claim 1 wherein a user identifies a retail price for a consumer good to the mobile device by speaking the price in U.S. currency.

7. The system of claim 1 wherein the mobile device display represents the user's spoken input thereon, and wherein the user edits the information represented by the display by speaking a command.

8. The system of claim 1 including a plurality of voice-enabled mobile data collection devices, wherein at least one of the mobile data collection devices receives voice input from an associated user in the form of a sale identifier for a first given product indicating that the first given product is on sale, and wherein the consumer goods price tracking component associates the sale identifier with the good-price pair to provide a good-price-sale triplet.

9. The system of claim 1 including a plurality of voice-enabled mobile data collection devices, wherein at least one of the mobile data collection devices receives voice input from an associated user in the form of a value identifier for a first given product indicating that the first given product has a value price associated therewith, and wherein the consumer goods price tracking component associates the value identifier with the good-price pair to provide a good-price-value triplet.

10. The system of claim 1 wherein no mobile device receives any communication from the processing engine while in a retail environment.

11. The system of claim 1 farther including an administrative user component for communicating a directed list to a user of the data collection device.

12. The system of claim 1 including a plurality of voice-enabled mobile data collection devices and wherein each of the plurality of devices communicates a good-price pair for each of a plurality of goods to the processing engine.

13. A method, comprising:
receiving voice commands via a voice-enabled mobile data collection device from a user as the user moves through a physical retail environment, with the device having a display;
associating, via a consumer goods price tracking component, consumer good identification information with a retail price received by voice from the user of the mobile data collection devices, so as to provide an associated good-price pair for each of a plurality of goods; and
audibly confirming, and validating, at least the retail price received by voice from the user in response to the received voice commands.

14. The method of claim 13 wherein the data collection device receives voice commands including a code input command, a price input command and a repeat price command.

15. The method of claim 13 wherein the consumer good identification information is entered by the user through one of: barcode scan, oral communication, key entry, captured image for optical character recognition.

16. The method of claim 13 including receiving voice commands via a plurality of voice-enabled mobile data collection devices, wherein each mobile device is operated by a different individual user in a unique physical retail establishment such that no two devices are operated in the same physical retail establishment at the same time.

17. The method of claim 13 wherein a user identifies a consumer good to the mobile device by speaking the product brand and name.

18. The method of claim 13 wherein a user identifies a retail price for a consumer good to the mobile device by speaking the price in U.S. currency.

19. The method of claim 13 wherein the mobile device display represents the user's spoken input thereon, and wherein the user edits the information represented by the display by speaking a command.

20. The method of claim 13 including receiving voice commands via a plurality of voice-enabled mobile data collection devices, wherein at least one of the mobile data collection devices receives voice input from an associated user in the form of a sale identifier for a first given product indicating that the first given product is on sale, and wherein the consumer goods price tracking component associates the sale identifier with the good-price pair to provide a good-price-sale triplet.

21. The method of claim 13 including receiving voice commands via a plurality of voice-enabled mobile data collection devices, wherein at least one of the mobile data collection devices receives voice input from an associated user in the form of a value identifier for a first given product indicating that the first given product has a value price associated therewith, and wherein the consumer goods price tracking component associates the value identifier with the good-price pair to provide a good-price-value triplet.

22. The method of claim 13 wherein no mobile device receives any communication from the processing engine while in a retail environment.

23. The method of claim 13 further including the step of communicating a directed list to a user of the data collection device via an administrative user component.

24. The method of claim 13 including receiving voice commands via a plurality of voice-enabled mobile data collection devices, and wherein each of the plurality of devices communicates a good-price pair for each of a plurality of goods to a processing engine.

25. A method for improving the accuracy of competitive price data collection and reporting, comprising:
providing a data collection device with a voice recognition/processing component for collecting pricing data in a retail establishment, wherein the mobile computing device includes a display;
associating, by the device, consumer good identification information with received pricing data so as to provide an associated good-price pair for a plurality of goods offered for sale within a retail establishment; and
validating, by the device, the accuracy of the collected pricing data by presenting a response to a user who inputs pricing data to the device using the voice recognition/processing component.

26. The method of claim 25 wherein the step of validating the accuracy of the collected pricing data includes presenting a visual response to the user on the device display.

27. The method of claim 25 wherein the step of validating the accuracy of the collected pricing data includes presenting an audible response to the user of the device.

28. A price collection apparatus for use with a retail data information management system, comprising:
a mobile computing device having a display and a voice recognition/processing component for receiving pricing data from a user collecting the pricing data; and
a consumer goods price tracking component for associating consumer good identification information with received pricing data so as to provide an associated good-price pair for a plurality of goods offered for sale within a retail establishment; and
a programmed module to validate the accuracy of the collected pricing data by presenting a response to the user.

29. The apparatus of claim 28 wherein the goods price tracking component validates the accuracy of the collected pricing data by presenting a visual response to the user on the device display.

30. The apparatus of claim 28 wherein the goods price tracking component validates the accuracy of the collected pricing data by providing an audible response to the user.
